(19) United States
(12) Patent Application Publication
(10) Pub. No.: US 2003/0007624 A1
(43) Pub. Date: Jan. 9, 2003

(54) Central administration of a call center

(76) Inventors: Peter Handel, Muenchen (DE); Soma Sarkar, Bangalore (IN); Uwe Herrmann, Ebersberg (DE)

Correspondence Address: Morrison & Foerster LLP, Suite 300, 1650 Tysons Boulevard, McLean, VA, 22102, US

(21) Appl. No.: 10/173,877

(22) Filed: Jun. 19, 2002

(30) Foreign Application Priority Data
Jun. 19, 2001 (DE) DE 10129322.4

(51) Int. Cl. H04M 7/00; H04M 5/00

(52) U.S. Cl. 379/220.01; 379/265.01

(57) ABSTRACT

The invention relates to the operation and administration of a call center, the network elements of which or the applications of which are distributed in a network and, in particular, are available via the Internet. In this arrangement, switches of a public network are linked into the administration. Communication between different network elements, particularly applications and servers from different domains takes place by converting interfaces of the applications into a protocol which is intended for interdomain communication.

### CLAIM FOR PRIORITY

This application claims the benefit of priority of German Application No. 101 29 322.4, filed Jun. 19, 2001, the contents of which are hereby incorporated by reference.

### TECHNICAL FIELD OF THE INVENTION

The invention relates to telecommunications, and in particular, to the operation, administration and monitoring of a switching facility such as a call center.

In particular, the invention relates to a method and to a device for controlling a number of processes and network elements of a system which are at least partially engaged in data exchange with one another, which are distributed in one or more domains in a network and which have at least one interface for communication purposes.

### BACKGROUND OF THE INVENTION

A call center is a service facility for telecommunication jobs of the most varied type. They distinguished by the fact that they forward or distribute telecommunication jobs from a transmitter—for example, telephone inquiries coming from the outside—automatically and in accordance with particular criteria to a receiver selected by the system. The advantage of call centers lies in the fact that no time-intensive re-transmitting to the appropriate contact party within a company or an authority is necessary because, as a rule, call centers are equipped with an automatic call distribution (ACD) system which automatically switches a call through to a particular appropriate agent and/or to an available colleague. These call distribution systems can either be integrated and assume the existence of specially designed terminals or are provided as a separate system which allows conventional telephone branch exchanges to be used.

Using servers designed for special tasks and accessing database systems enables fast access to all relevant data to be guaranteed. Using computer telephone integration (CTI) technology, the incoming calls are linked to a database so that a data input by the agent handling the call for retrieving further information during the call is possible.

Modern call centers have a multiplicity of additional functions such as, for example, the automatic carrying-out of ordering processes, etc. The servers used for this purpose which exchange data with one another and access one or more databases must always access a consistent database and must be maintained for freedom from errors. Apart from the increased functionality of such systems, their administrative expenditure also increases.

Due to the increasing networking, call centers are frequently distributed over different domains: accordingly, a call center can be split into a main site and a number of call center branches. This tremendously increases the complexity of the entire system and thus also the expenditure for controlling and administering the call center. A system is therefore required which can considerably minimize the administrative expenditure.

As a rule, the databases of the network elements of a call center are organized to be decentralized, and are, therefore, distributed throughout the network. To be able to guarantee the necessary data exchange with the databases, high demands are made on the operation and administration of these databases. Until now, each administrative task had to be executed in a decentralized manner at the respective network element. This leads to multiple processing, entails cost- and maintenance-intensive multiple installations and increases the gaps in security due to multiple interdomain communication.

As a rule, call centers have a heterogeneous environment due to the distributed network elements so that the respective network elements are based on different information technology platforms (e.g. different operating systems such as Windows NT and UNIX). Thus, it has hitherto not been possible to integrate either groups of network elements based on different IT platforms or to jointly control all network elements centrally.

### SUMMARY OF THE INVENTION

In one embodiment of the invention, there is a method and a device which provides the operator of the system, particularly of the call center, with an inexpensive, simpler and uniform administration and control of network elements and increases the possible applications by operating independently of the individual protocols or interfaces of the respective applications or of the network elements.

In another embodiment of the invention, the processes and/or network elements are controlled jointly and centrally and the invention decouples the interfaces of the network from the interfaces of the processes for the data exchange between the processes which takes place via switches of the network.

In another embodiment of the invention, there is a device of the type initially mentioned, which comprises the following:

a control device which jointly and centrally controls all processes and/or network elements, and

a conversion device which decouples the interfaces of the network from the interfaces of the processes and network elements.

In one aspect of the invention, call centers, of the above-mentioned type, has devices distributed throughout the network and centrally operated and/or administered.

In the invention, the data exchange between the processes or applications or the individual network elements takes place via switches of the network, preferably of the public switched telephone network (PSTN). According to the invention, a protocol conversion takes place in these cases so that the interfaces of the public network are decoupled from the interfaces of the call center so that a change of the interface to a switch does not force a change of the interface within the call center, particularly of the application. However, it is also possible that the data exchange between the applications does not take place via the switches of the network. There is then no protocol conversion according to the invention.

According to another embodiment of the invention, the interfaces are decoupled by converting the interface of the application into a protocol which is suitable for the communication between different domains. After the interdomain communication, another protocol conversion takes place. The protocol is reconverted in such a manner that it corresponds to the respective application addressed or, respectively, the network element addressed. The direct communication path is thus diverted and the interfaces of the network elements involved in the communication process are converted into a transmission protocol once at the call center end and once at the network operator end. The transmission protocol is designed in such a manner that it is suitable for interdomain communication.

In a preferred embodiment of the invention, the system exhibits a call center server application which takes over the communication coordination between a client on which a specially adaptable user interface is running, and other network elements. The call center server application is also used for transaction monitoring and terminates the interface with respect to a remote user server at the call center end. Furthermore, it represents the interface to a telecommunication network management (TNM) network application with respect to the client.

The system according to the invention can be advantageously used for administering and operating both inbound and outbound call centers. In the case of inbound call centers, an external customer call—a call center job—is forwarded by the call center to the suitable agent. Examples of this are product information, ordering requests or complaints. In the case of outbound call centers, only outgoing telephone calls to selected customers are handled, for example market research, direct marketing or address verifications.

In one aspect of the invention, the user of the call center, who can transmit and/or receive call center jobs, in this exemplary case the client, is equipped with an integrated user interface in which network elements and objects to be administered are represented, even if they belong to different domains. The user can advantageously and optionally set the display to the call center to be administered. Depending on the type of control and monitoring task, the call center can be optionally structured in accordance with network elements or in accordance with data objects. The user interface supports the administration and control tasks and has a graphic interface. The user is also supported by additional tools such as, for example, error detection and analysis or a configuration aid.

One advantage of the system is that the method is independent of protocols since the respective protocols are converted or, respectively, converted and reconverted in such a manner that platform-independent interdomain communication and intradomain communication is possible. In the case of the interdomain communication, currently available firewall mechanisms are used so that the usual interfaces existing within a domain such as, e.g. DCOM or CORBA, will not be used. According to the invention, the interfaces are, therefore, converted into a protocol which is intended for communication between different domains, e.g. the Simple Object Access Protocol (SOAP) using the extensible markup language (XML) in order to be subsequently reconverted again into a protocol which is designed for communication within a domain and provides the normally used interfaces to the applications.

The SOAP protocol is used for providing for communication between different applications directly via the Internet without being blocked by firewalls.

In the HTTP protocol normally used, so-called remote procedure calls are not supported. Although they are protocols allowing access to remote applications such as DCOM (Distributed Component Object Model) by Microsoft and IIOP/CORBA, for the communication within a domain, these protocols based on distributed systems cannot be used for interdomain communication due to the existing firewalls.

The SOAP protocol is based on the HTTP protocol as transport protocol and bypasses the obstacle of the firewalls and, therefore, provides for communication or data exchange via the World Wide Web (WWW).

In a preferred embodiment of the invention, the system also includes switches which can exhibit an automatic call distribution system, of servers for different subtasks and of agent terminals of the call center.

An advantage for practical applications is that the switches of the public network, particularly of the telephone network, are included in the administration of the call center system. This makes it possible to accelerate the necessary data exchange, particularly voice data exchange, and to optimize the quality of the call center administration.

According to another embodiment of the invention, the security aspect of the data transmission between different domains via the Internet has also been taken into consideration for the administration of the call center.

The possibility, according to the invention, of central, joint administration of databases creates the important advantage that inconsistencies which have hitherto occurred can be eliminated since any change in a database is immediately synchronized via network elements. Error sources have previously arisen due to the decentralized administration of the network elements and the resultant risk of inconsistencies.

The administration of the call center comprises, in the preferred embodiment, a setting-up and administering of the databases of the different network elements, operation, remote maintenance and monitoring of the network elements, particularly with an interrogation of status information and the reception of alarms.

Due to the possibility of central administration, the costs of the system, particularly the administrative costs, can be lowered and personnel can be used much more efficiently. If, for example, the automatic call distribution system is distributed over a number of switches, an increased administrative expenditure arises. If such a system is to be operated, administered and monitored, it has hitherto been necessary to administer network elements in a decentralized and mutually independent manner.

### BRIEF DESCRIPTION OF THE DRAWINGS

Further advantages of the invention and particular embodiments and features are represented in the detailed description of the figures below. In the figures:

FIG. 1 shows an exemplary representation of an interdomain communication of a call center.

FIG. 2 shows an exemplary representation of communication sequences according to the present invention.

FIG. 3 shows an exemplary representation of various network elements of the call center which exchange data with one another.

FIG. 4 shows an overview representation of interfaces according to the invention.

FIG. 5 shows a diagrammatic representation of an interdomain communication.

### DETAILED DESCRIPTION OF THE PREFERRED EMBODIMENTS

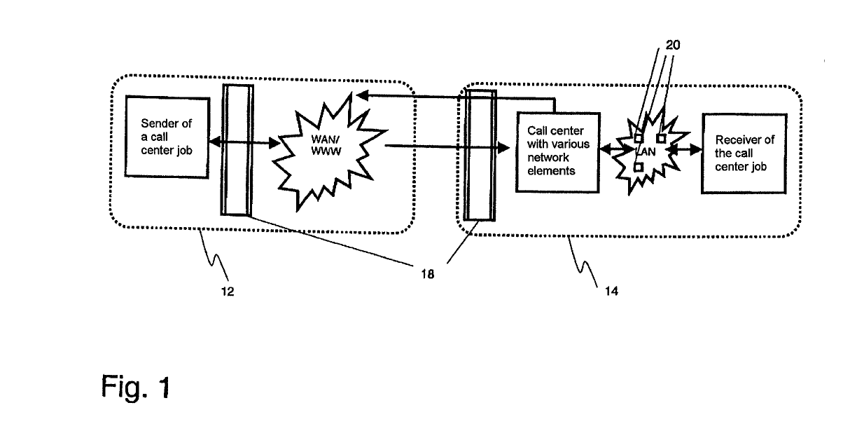

In the text which follows, and referring to FIG. 1, the basic sequence of a call center generally designated by 10 will be briefly presented by way of an introduction.

A sender of a call center request sends his request by telephone via a PSTN network or via computer via the Internet (e.g. Internet Telephony) to the call center 10. There, the request is forwarded to a receiver to be determined by the call center 10 via a number of intermediate stations. The intermediate stations or switches 20 of the call center 10 are connected to one another via a network which can be a LAN or a WAN. Preferably, when a computer communicates via the Internet, a firewall 18 will be set up in order to meet the security aspects of the Internet communication.

FIG. 1 shows that network elements of the call center 10 are connected to one another by means of a local area network. However, it is also possible that the call center is distributed over various sites which exchange data via a wide area network (WAN) or, respectively, the WWW.

The method according to the invention can then also be applied to the exchange of call center-related data from different domains.

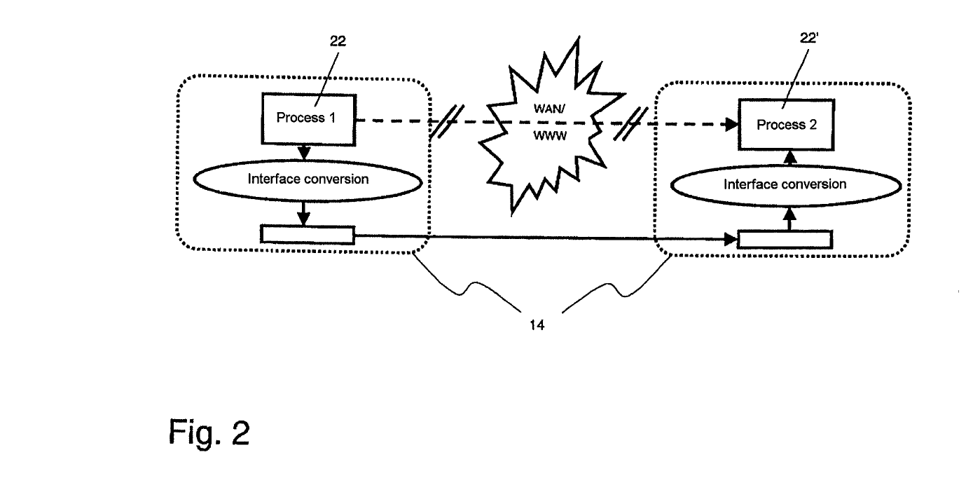

As shown in FIG. 2, a process—in this case a first application 22—can communicate with another process in this case a second application 22′ of the call center 10. The applications 22, 22′ can be distributed in different domains 14 of the call center. Interdomain communication therefore becomes necessary. FIG. 2 shows only one path of the communication from application 22 to application 22′ (in the direction of the arrow). Preferably, bi-directional communication will be set up.

FIG. 2 shows by way of example the case where a call center server application and another call center server application are communicating. However, it is also within the scope of the invention that arbitrary other network elements communicate with one another such as, for example, a client 30 with a server or an agent terminal 32.

Due to the firewall mechanisms, it is not possible to use the usual protocols for communication of distributed objects within a domain (e.g. DCOM/CORBA) since these do not support function calls via the Internet—so-called remote procedure calls. This is why, according to the invention, the Simple Object Access Protocol (SOAP) is used which provides the last-mentioned functionality. The communication from application 22 to application 22′ is diverted, as it were, by converting the interfaces into the suitable protocol and reconverting them again after the data transmission has been concluded.

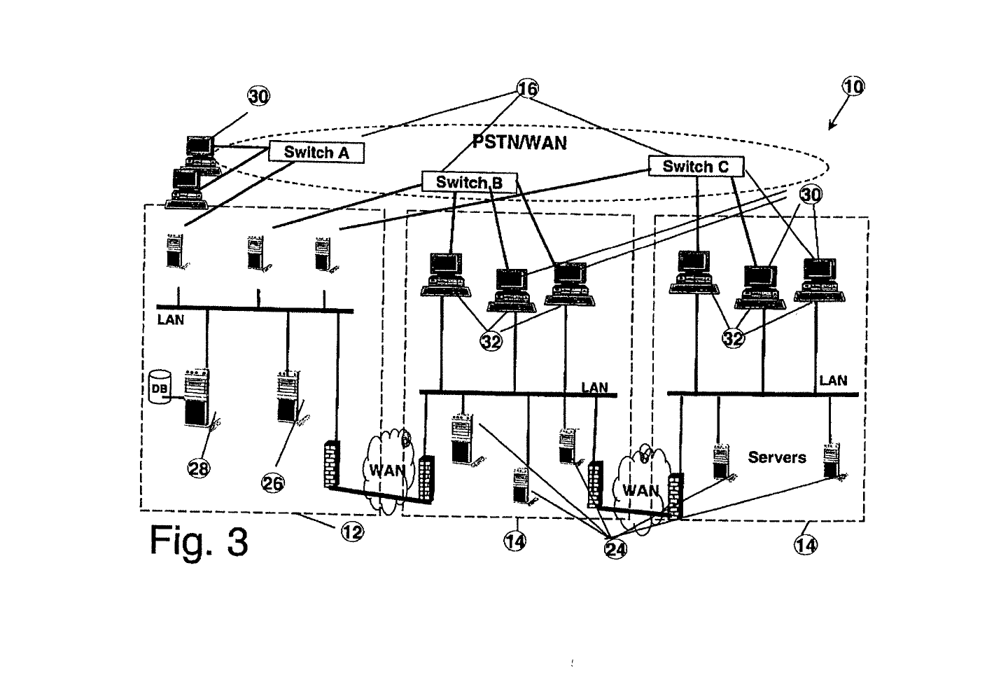

FIG. 3 diagrammatically shows an exemplary structure of a call center administration according to the invention. At the top left, agent terminals 32 are shown which, by way of example, are intended to represent the computers of the agents of the call center whose work stations cannot necessarily be located at the call center site. They communicate with the other network elements of the call center 10 via the public network (PSTN) and its switches 16. This area falls into the domain of the network operator 12. In the three dashed frames shown in FIG. 3, different domains are to be shown which are essential in this configuration. On the left, the domain of the network operator 12 is shown. It comprises the management of the network nodes.

In the center frame, the call center main site is shown with the corresponding servers, and the right-hand frame is intended to identify, for example, a branch location of the call center with its respective agent stations and servers. The network elements within a domain are connected to one another via a LAN. Communication between the domains is carried out via the firewalls 18 and a WAN, particularly the Internet.

FIGS. 3 to 5 show the individual components of one advantageous embodiment:

one or more call center server applications 22, 22′,

a multiplicity of clients 30 on which the user interface of application 22, 22′ is running,

a remote user server 26 which is used if the call center and its switches 16 are not within the same domain,

a network application 28 for the network-wide administration of the switches 16,

various servers 24 which are provided for different tasks, and

a multiplicity of agent terminals 32.

The server application or application 22, 22′, respectively, handles the communication coordination between the client 30 and the network application 28, the servers 24 or the agent terminals 32, respectively. The application 22, 22′ also monitors the transactions and terminates the interface with respect to the remote user server 26 at the call center end. Furthermore, it represents the interface to the network application 28 with respect to the client 30.

The application 22, 22′ handles the management of the individual network elements and their coordination. It is also responsible for the communication with the remote user server 26 and performs the protocol conversion at the call center end.

The network application 28 has access to the basic information of the public network relating to the forwarding and routing of a telecommunication job. In particular, these are the address of the switches 16, the administrative interfaces and root information for the data objects which are to be addressed within the call center 10. According to the invention, this basic information is stored in a database. If a parameter changes in this database, these changes are immediately followed up in other entries relating to this parameter so that it is always possible to access a consistent database.

The network application 28 is able to administer the databases of the switches 16 since it has access to data of the switches 16, for example their administrative interfaces and root information of the elements of the databases of the call center 10 which are necessary for addressing purposes.

According to one embodiment of the invention, the interfaces are decoupled from one another so that a change in the interface to switch 16 does not force any change in the interface of application 22, 22′.

This is accomplished by translating an administrative or control job into a proprietary command syntax of the switches. The result of this translation process is then transmitted from the network application 28 to the client 30. The translation process then takes place inverted at the other end of the communication.

The network application 28 is designed in such a manner that it converts the high-level requests of the call center 10 in such a manner that they can enter into a data exchange with the switches and then process these in a transaction-protected manner.

The network application 28 can also split a call center job and/or a call center administration job into sub-jobs in order to increase the performance of the overall system.

In an advantageous embodiment, the remote user server 26 is used for establishing the interface to the area of the network operator. According to the invention, the systems in which the call center operator is not identical with the operator of the public network are also supported. This constellation creates a security problem since different domains communicate with one another and are integrated with one another. Preferably, the call center operator can also access limited resources of the network operator during the database accesses. According to the invention, the remote user server 26 is used, therefore, to provide for interdomain communication via firewall mechanisms and to meet other security functions such as, for example, an authentication and authorization check of a call center user who, outside the domain of the call center, wishes to access network elements inside the domain of the call center or switches.

Compared with the network application 28, the remote user server 26 represents one or more clients 30. Furthermore, it terminates the interface to the application 22, 22′ at the telecommunication network management (TNM) end and is used for protocol conversion at the public network end.

In particular, the method can also be used when the automatic call distribution (ACD) system is distributed over a number of switches. According to the invention, a centralized administration of the network elements is now also possible in this case.

At the agent terminal 32, an agent of the call center optionally processes the jobs by means of different media such as telephone, email, fax etc. The agent terminal can contain the client 30 for the application 22, 22′—but does not need to.

In an alternative embodiment, the call center also switches image data or other media in addition to telephone calls.

It is an advantage of the method that the control of the system, particularly of the call center, is platform-independent since the protocols on which the method is based, such as SNMP/XML, for example, are platform-independent.

A further advantage of the method can be seen in the fact that the network elements can have databases which are organized in a decentralized manner and are distributed throughout the network and that the method, nevertheless, can be centrally administered.

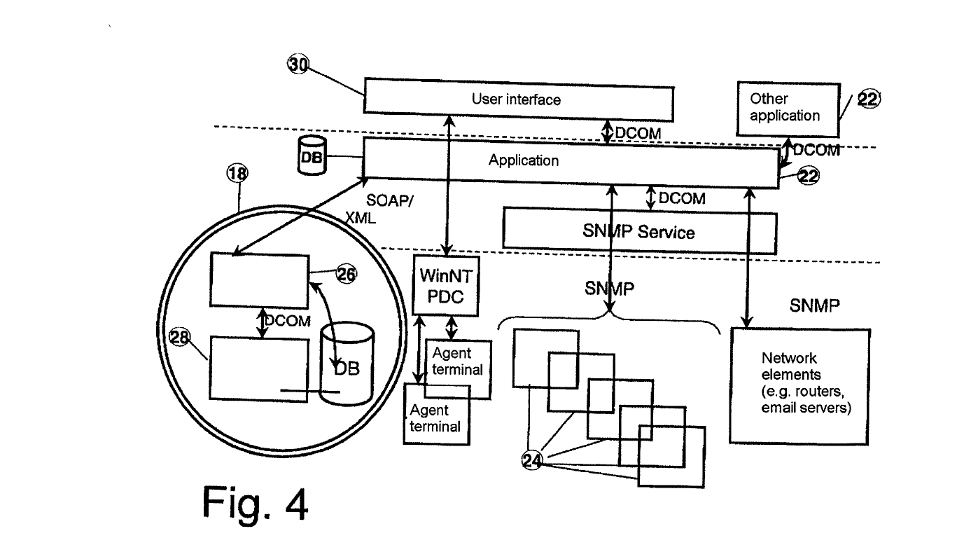

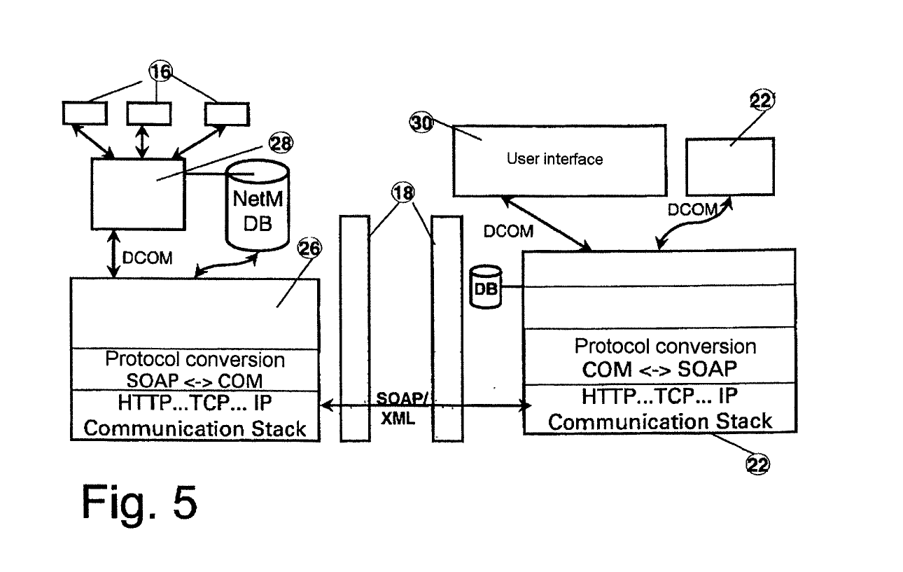

FIGS. 4 and 5 show the interfaces and their communication sequences. The two dashed lines in FIG. 4 are intended to identify the type of network elements. The agent stations are shown above the top line. Application 22 is located in the center and the remaining network elements are shown below the lower line.

FIG. 5 shows in greater detail the protocol conversion with the respective processes indicated in FIG. 2.

What is claimed is:

1. A method for controlling a number of processes and/or network elements of a system which are at least partially engaged in data exchange, and which are distributed in one or more domains in a network and which have at least one interface for communication, comprising:
controlling the processes and/or network elements jointly and centrally; and
decoupling the at least one interface of the network from the at least one interface of the processes, during the data exchange between the processes, which takes place via switches of the network.

2. The method as claimed in claim 1, wherein the system is a call center with a multiplicity of network elements.

3. The method as claimed in claim 2, wherein the call center is an inbound call center and/or an outbound call center.

4. The method as claimed in claim 1, wherein the processes are applications and/or network elements and at least partially run on heterogeneous information technology platforms.

5. The method as claimed in claim 1, wherein the at least one interface is decoupled by converting the at least one interface of the process into a protocol which is suitable for communication between different domains and is subsequently reconverted again.

6. The method as claimed in claim 2, wherein the communication between the processes and/or network elements is at least partially based on switches of the public network, the interfaces of the processes being at least partially converted in such a manner that they correspond to the at least one interface of the switches.

7. The method as claimed in claim 2, wherein the network elements belong to one and/or different domains.

8. The method as claimed claim 1, wherein the at least one interface for the data exchange between the domains is converted into a protocol which is intended for interdomain communication.

9. The method as claimed in claim 1, wherein the network is a local area network and/or a wide area network.

10. The method as claimed in claim 1, wherein a public switched telephone network is coupled with a packet-oriented network.

11. The method as claimed in claim 1, further comprising organizing a user interface with different structurings of the call center.

12. The method as claimed in claim 1, wherein the control is split into sub-processes.

13. The method as claimed in claim 12, wherein the control comprises the operation, monitoring and/or remote maintenance of network elements and/or a setting-up of databases of the network elements.

14. A device for controlling a number of processes and network elements of a system which are at least partially engaged in data exchange with one another, which are distributed in one or more domains in a network and have at least one interface for communication, comprising:
a control device which jointly and centrally controls processes and/or network elements; and
a conversion device which decouples the at least one interface of the network from the at least one interface of the processes and network elements.

15. The device as claimed in claim 14, wherein the system is a call center and comprises:
at least one client;
at least one network application;
at least one application which is configured for communication coordination between the client and other network elements and which represents the at least one interface with respect to the network application and which is configured for decoupling the at least one interface;
at least one server; and
a multiplicity of agent terminals.

16. The device as claimed in claim 15, further comprising:
a remote user server which is configured for data exchange with switches of the network and/or the network application and for protocol conversion.

17. The device as claimed in claim 14, wherein the device comprises an automatic distribution facility which is configured for the automatic distribution of a call center job to an agent terminal.

18. A system for operating and/or administering a number of devices as claimed in claim 14, wherein the devices are distributed throughout the network and are centrally operated and/or administered.

19. The method as claimed in claim 3, wherein the communication between the processes and/or network elements is at least partially based on switches of the public network, the interfaces of the processes being at least partially converted in such a manner that they correspond to the at least one interface of the switches.

20. The method as claimed in claim 4, wherein the communication between the processes and/or network elements is at least partially based on switches of the public network, the interfaces of the processes being at least partially converted in such a manner that they correspond to the at least one interface of the switches.

21. The method as claimed in claim 5, wherein the communication between the processes and/or network elements is at least partially based on switches of the public network, the interfaces of the processes being at least partially converted in such a manner that they correspond to the at least one interface of the switches.

22. The device as claimed in claim 15, wherein the device comprises an automatic distribution facility which is configured for the automatic distribution of a call center job to an agent terminal.

23. The device as claimed in claim 16, wherein the device comprises an automatic distribution facility which is configured for the automatic distribution of a call center job to an agent terminal.

24. A system for operating and/or administering a number of devices as claimed in claim 15, wherein the devices are distributed throughout the network and are centrally operated and/or administered.

25. A system for operating and/or administering a number of devices as claimed in claim 16, wherein the devices are distributed throughout the network and are centrally operated and/or administered.

26. A system for operating and/or administering a number of devices as claimed in claim 17, wherein the devices are distributed throughout the network and are centrally operated and/or administered.
